(19) United States
(12) Patent Application Publication
(10) Pub. No.: US 2021/0092900 A1
(43) Pub. Date: Apr. 1, 2021

(54) Plant Pickers, And Related Methods Associated With Yield Detection

(71) Applicant: Monsanto Technology LLC, St. Louis, MO (US)

(72) Inventors: Adrian A.W. CARTIER, St. Louis, MO (US); Fei CHEN, St. Louis, MO (US); Mackenzie A. KOLBET, Foristell, MO (US); Patricio S. LA ROSA ARAYA, St. Louis, MO (US); E. Scott MORRIS, Denton, TX (US); Alexander H. SHERIDAN, St. Charles, MO (US); Vallapakrishna SREERAM, St. Louis, MO (US)

(21) Appl. No.: 17/037,547

(22) Filed: Sep. 29, 2020

Related U.S. Application Data
(60) Provisional application No. 62/908,028, filed on Sep. 30, 2019.

(51) Int. Cl. A01D 41/127; G05B 19/4155; A01D 46/30; A01D 45/02

(52) U.S. Cl. CPC A01D 41/127; G05B 19/4155; H04L 67/12; A01D 45/02; A01D 46/30

(57) ABSTRACT

Systems and methods are provided for adapting picker yield data collected by pickers (e.g., ear pickers, combines, etc.) to account for errors in calibration of the pickers. One exemplary computer-implemented method includes accessing data for a field harvested by multiple pickers, wherein the accessed data includes yield data for the field received from of the pickers, and determining a mass differential for a crop harvested by the pickers from the field. When the mass differential exceeds a threshold, the method then further includes calculating a normalization factor for at least one pair of the pickers, calculating a scaling factor associated with one of the pickers of the at least one pair of the pickers based on the normalization factor, and applying the scaling factor to the yield data received from the pickers such that the yield data is normalized.

### CROSS-REFERENCE TO RELATED APPLICATION

This application claims the benefit of, and priority to, U.S. Provisional Application No. 62/908,028, filed on Sep. 30, 2019, the entire disclosure of which is incorporated herein by reference.

### FIELD

The present disclosure generally relates to machines for harvesting plants (e.g., ear pickers, combines, etc.) (broadly, pickers) and related methods, including yield detection processes associated with such machines, and more particularly, to systems and methods related thereto for use in estimating, correcting, etc. yield data from the plant harvesting machines and removing measurement error from such yield data.

### BACKGROUND

This section provides background information related to the present disclosure which is not necessarily prior art.

Plants are known to be grown in fields for commercial purposes. At a point in the growing cycle of a plant, it is harvested or picked by a human or a machine (e.g., a picker, etc.). Manual picking is known to be labor intensive and tedious. Mechanized pickers are known to include ear pickers, combines, etc., for example, which provide advantages over manual picking. Apart from the picking functionality of the mechanized pickers, such pickers have more recently been employed to collect data related to the plants being picked. Specifically, for example, yields of plants or crops may be measured, by mechanized pickers, as the pickers traverse fields picking the plants or crops.

### DRAWINGS

The drawings described herein are for illustrative purposes only of selected embodiments and not all possible implementations, and are not intended to limit the scope of the present disclosure.

FIG. 1 illustrates an exemplary system of the present disclosure for determining crop yields of fields as measured by one or more machines (e.g., pickers such as ear pickers, combine harvesters, etc.; etc.) employed to harvest crops in the fields;

FIG. 2 is a graphical representation of an exemplary yield function for a picker in a field in the system of FIG. 1, either when the picker is well-calibrated, or when the picker overestimates or underestimates the yield of the crop harvested from the field;

FIG. 3 is a block diagram of a computing device that may be used in the exemplary system of FIG. 1;

FIG. 4 is an exemplary method, suitable for use with the system of FIG. 1, for determining a yield for a field harvested by one or more pickers;

FIG. 5 illustrates an example yield map that may be displayed to a user associated with harvesting a field in connection with the present disclosure;

FIG. 6 is a graphical representation of scaling factors that may be generated and implemented in the present disclosure in connection with an example normalization of yield data for synthetic fields harvested by one or more pickers;

FIG. 7 is a graphical representation of errors used in generating the synthetic fields in the example normalization of FIG. 6;

FIG. 8 is a graphical representation of residual root mean square error in connection with an example normalization of yield data for the synthetic fields harvested by two pickers;

FIG. 9 is a graphical representation of ratios of the residual root mean square errors of FIG. 8 to corresponding root mean square errors before the normalization of the yield data;

FIG. 10 is a graphical representation of residual root mean square error in connection with an example normalization of yield data for the synthetic fields harvested by three pickers;

FIG. 11 is a graphical representation of ratios of the residual root mean square errors of FIG. 10 to corresponding root mean square errors before the normalization of the yield data;

FIG. 12 is a graphical representation of residual root mean square error in connection with an example normalization of yield data for the synthetic fields harvested by more than three pickers;

FIG. 13 is a graphical representation of ratios of the residual root mean square errors of FIG. 12 to corresponding root mean square errors before the normalization of the yield data;

FIG. 14 is a map illustrating different swaths of a field harvested by two different pickers;

FIG. 15A illustrates yield distributions in the field of FIG. 14 for each of the two different pickers prior to normalization of the corresponding yield data for the field as described herein; and

FIG. 15B illustrates yield distributions in the field of FIG. 14 for each of the two different pickers, after normalization of the yield data as described herein.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Commercial development of seeds, grains, etc., as well as planting plans for such seeds, grains etc., fertilization plans, irrigation plans, pest control, location (e.g., growing environments, geospatial data, etc.), etc., often relies on data related to origins from which the seeds, grains, etc. are to be developed, growing spaces, and other data. Common examples of such data include, without limitation, plant stalk strength, root strength, yield, disease tolerance, stress tolerance, plant height, ear height, etc. As can be appreciated, the data may be different depending on the particular crop and/or seed and/or grain being developed. And, as different schemes are created to better develop seeds, grains, etc., the mechanisms used to implement the schemes are often increasingly reliant on such data. As such, techniques may be implemented to ensure the validity and/or accuracy of the data being gathered in the fields or elsewhere with regard to the seeds/plants/grains, so that the mechanisms of seed, grain, etc. development are effective in providing improvements over prior seed, grain, etc. development mechanisms (e.g., to make sure accurate data is being used by the mechanisms, etc.).

Uniquely, the systems and methods herein permit for error correction of data gathered in a field, as plants are harvested (e.g., corn, soybean, cotton, canola, wheat, etc.), by different harvesting machines (including ear pickers, combines, etc. (all broadly referred to as pickers herein)), whereby more accurate data is achieved, for example, for subsequent use in connection with commercial development of the underlying seeds, grains, etc. In particular, the systems and methods herein permit for minimizing, or even removing, systematic measurement errors typically present in the data gathered for the field by the different pickers, etc., for example, based on variations and/or problems in calibrations between and/or with the pickers (e.g., based on one or more pickers being not well calibrated such that measurement error may exist in yield data collected therefrom, etc.). As a practical application, then, the systems and methods herein address (and minimize or even remove) potential bias that may be introduced to such data by pickers that are not well calibrated, and allow users to more readily analyze accurate yield data, for example, and identify portions of field that have better performance than others (e.g., to differentiate high-yield areas versus low-yield areas in the field, etc.). In this way, for example, yield data for the pickers may be adjusted, scaled, etc. as desired.

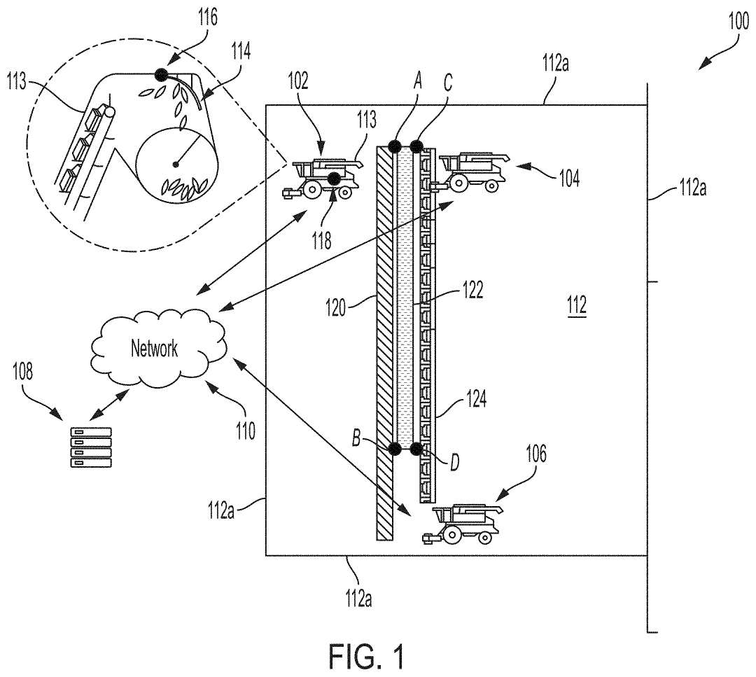

With reference now to the drawings, FIG. 1 illustrates an exemplary system 100 for use in collecting and altering (e.g., normalizing, etc.) data associated with harvesting crops within one or more fields, in which one or more aspects of the present disclosure may be implemented. Although, in the described embodiment, the system 100 includes fields and pickers, etc. presented in one arrangement, other embodiments may include the same or different features (and/or number of features) arranged otherwise depending, for example, on types of crops being harvested (e.g., corn, soybean, cotton, canola, wheat, etc.), numbers of pickers being employed, types of pickers being employed (e.g., ear pickers, combine harvesters, etc.), relationships of the fields to one another, privacy concerns and/or restrictions, whether other machinery is being used to assist in harvesting the crops (e.g., machinery other than pickers such as hauling trucks, etc.), etc.

As shown in FIG. 1, in this example embodiment, the system 100 generally includes multiple pickers 102-106 (e.g., ear pickers, combine harvesters, etc.) and a field engine 108, each coupled to a network 110. The network 110 may include, without limitation, a local area network (LAN), a wide area network (WAN) (e.g., the Internet, etc.), a mobile/cellular network, a virtual network, and/or another suitable public and/or private network capable of supporting communication among two or more of the parts illustrated in FIG. 1, or any combination thereof. For example, each of the pickers 102-106 may be configured to communicate with the field engine 108 via the network 110, and may further be configured to communicate with each other (also via the network 110).

In the illustrated embodiment, each of the pickers 102-106 is disposed within a field 112, where the field 112 is designated by boundaries (or boundary lines) 112a. In addition, various other fields may be located about (or around) the field 112 (sharing one or more of the boundary lines 112a), as is common in an agricultural setting. Further, any suitable crop may be provided in the field 112 for harvesting by the pickers 102-106. For example, the field 112 may include maize or corn (whereby the pickers 102-106 may be corn ear pickers or combine harvesters), where plants have grown to sufficient height and/or maturity such that the plants are ready to be harvested. That said, it should be appreciated that the present disclosure is not limited to harvest of maize or corn, and is also applicable to the harvest of other crop species (as described herein).

In connection therewith, each of the pickers 102-106 is disposed in the field 112 and configured to harvest plants as the respective picker moves across the field 112 (and over the crop).

In one example, where the plants in the field 112 include corn, at least one of the pickers 102-106 may include a common ear picker such as a corn harvester. For instance, in FIG. 1, the picker 102 may include such a corn harvester (while one or more of the other pickers 104-106 may also include corn ear pickers or one or more may include a combine harvester, etc.). In connection therewith, the example picker 102 is configured to cut corn stalks and strip the corn from the stalks. The picker 102 is then configured to advance the harvested corn through a chute 113 toward a plate 114 (on board the picker 102), which directs the corn into a bin (e.g., pulled behind the picker 102, driven next to the picker 102, etc.) and which may then define (or may be transferred to a truck to define) a truckload of corn from the field 112.

The picker 102 also includes a sensor 116 configured to sense the corn as it passes through the chute 113. In the example picker 102, the sensor 116 is an impact sensor associated with (e.g., disposed on, coupled to, etc.) the plate 114. As such, when the corn (stripped from the stalks) strikes the plate 114, as it is propelled through the chute 113 by the picker 102 (on its way to the bin), the sensor 116 is configured to generate an electrical signal indicative of the impact force of the corn on the plate 114 (e.g., indicative of the corn striking the plate 114 in general, indicative of an amount of force imparted by the corn striking the plate 114, etc.) and transmit the signal to the picker 102 (via the network 110, via a direct link between the sensor 116 and a computing device of the picker 102 (which may or may not be part of the network 110), etc.). In turn, the picker 102 is configured to collect and store data indicative of the electrical signals generated by the impact on the sensor 116 over time (e.g., in a data structure associated with the sensor 116, associated with the picker 102, etc.), whereby the electrical signals serve as a proxy for an amount (and yield) of the crop being harvested from the field 112 (e.g., as an indicator of how much corn is being harvested by the picker 102 and flowing through the chute 113, etc.). In particular, the sensor 116 and/or the picker 102 may use the electrical signals to calculate a yield for the field 112, as described more hereinafter. While the sensor 116 is illustrated as being positioned on the plate 114 of the picker 102 in FIG. 1, in other exemplary embodiments, the sensor 116 may be separate from the plate 114 and spaced apart from the plate 114 (e.g., not disposed on the plate 114, etc.) but still configured to generate electrical signals for the corn as the corn is picked by the picker 102 and/or impacts the plate 114. What's more, in still other exemplar embodiments, sensors other than electrical impact sensors may be used to identify corn passing through the chute 113 in connection with determining a yield. For example, in some embodiments, optical sensors may be used (e.g., positioned adjacent, within, etc. the chute 113 of the picker 102, etc.), etc.

That said, in this example, the picker 102 is subject to calibration, where a linear relationship is determined in order to define the yield or corn flow from the field 112 (through the picker 102) as a function of the electrical signals from the impact sensor 116. This may be done via communication by a calibration computing device with the sensor 116 and/or with the picker 102 via the network 110, or it may be done on site directly at the picker 102. It should be appreciated that, while such calibration is described with regard to the picker 102 (and with regard to the picker 102 being a corn ear picker), it may also apply to the pickers 104 and 106 (regardless of whether the pickers 104 and 106 are corn ear pickers, combine harvesters, or other harvesting machinery). In connection therewith, where the pickers 104 and/or 106 include combine harvesters, a similar sensor may be included to sense the corn as it enters the combine harvester (e.g., from a corn header, etc.), as it passes through the combine harvester, as it is collected and/or discharged from the combine harvester (e.g., via a chute similar to chute 113, etc.), etc. And again, the discussion herein should also be understood to be applicable to plants or crops other than corn.

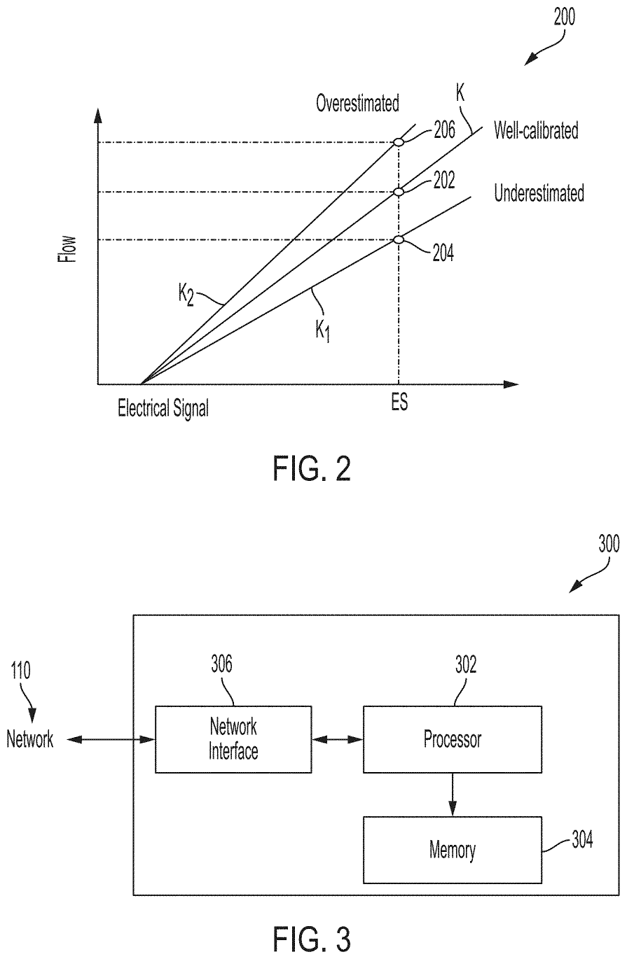

In connection with such calibration, FIG. 2 illustrates an example linear function K relating to the electrical signals collected and stored by the picker 102 with regard to flow of corn through the picker 102, where the linear function K is “well-calibrated” and defines the linear relationship (e.g., defines a response curve with slope K, etc.) between the electrical signals received from the sensor 116 in the picker 102 and the corn flow through the picker 102 (i.e., the linear function K provides a basis for which the sensor 116 (or the picker 102) calculates yield data for the field 112 (see, e.g., Equation (1))). Similar functions may be associated with the pickers 104 and 106 (regardless of whether the pickers 104 and 106 are corn ear pickers, combine harvesters, or other harvesting machinery).

As such, in this example for the picker 102, for a given electrical signal, ES, generated by the sensor 116 (located along the horizontal axis of the graph in FIG. 2), the function K provides a corresponding flow value of the corn through the picker 102 (located along the vertical axis of the graph), at point 202. FIG. 2 also illustrates a linear function K₁ (e.g., a response curve with slope K₁, etc.), which is “underestimated” with respect to the flow (e.g., where K₁ represents the linear function K when it drifts in a first direction when the picker 102 is out of calibration, etc.), and a linear function K₂ (e.g., a response curve with slope K₂, etc.), which is “overestimated” with respect to the flow (e.g., where K₂ represents the linear function K when it drifts in a second direction when the picker is out of calibration, etc.). As illustrated by the function K₁, when the linear function K drifts to “underestimated,” at function K₁, the flow of corn determined for the picker 102 drops (at the same electrical signal ES) to the point 204. And, when the linear function K drifts to “overestimated,” at function K₂, the flow of corn determined for the picker 102 rises (at the same electrical signal ES) to the point 206. In both the “overestimated” and “underestimated” cases, the determined flow of corn, based on the electrical signal ES, is incorrect. As such, from time to time, the picker 102 is calibrated (e.g., remotely, etc.) to adjust the function K so that it is “well calibrated” to aid in the accurate determination of yield of the corn being harvested through the picker 102 (and, similarly, through the pickers 104 and 106). However, the calibration may not always be completed and/or regularly completed, which may then give rise to unknown errors specific to calculated yields for each of the pickers 102-106. These scenarios, and their corresponding unknown errors, are uniquely addressed herein by the field engine 108 in the manner described below.

Referring again to FIG. 1, the picker 102 in the system 100 (and potentially the other pickers 104 and 106) further includes a GPS system 118, which is configured to determine the location of the picker 102 over time. In connection therewith, the picker 102 is configured to tag the electrical signals generated by the sensor 116 (or associated data) (based on the impact of the corn against the plate 114) with location data determined by the GPS system 118, such that the corresponding yield (as calculated based on the associated electrical signals) can be identified to particular locations within the field 112. Additionally, similar to the data collected from the sensor 116, the picker 102 is also configured to capture and store the location data received from the GPS system 118 of the picker 102 over time (and/or for a desired interval), in association with the calculated yield data, for example, in a data structure in communication with the picker 102, etc. The location data is further correlated to the field 112 (e.g., by the picker 102, by the field engine 108, etc.), whereby a location of the picker 102 within the specific field 112 is known at various times (as well as yield data for the field 112 at the times).

Also in the illustrated embodiment, each of the pickers 102-106 has completed a pass across the field 112. In so doing, the picker 102 has completed a swath, referenced 120, in the field 112. The length of the swath 120 is determined, at least in part, by the GPS system 118 (at desired times) and the width of the swath is generally between about 15 and 20 meters (in this example, based on a width of the picker 102, etc.), but may be otherwise for other pickers (e.g., depending on a picking width of the other pickers, etc.). In connection therewith, an area of the field 112 from which corn is collected by the picker 102 may be determined, based on the dimensions of the swath 120. And, a rate of such collection may be determined based on the area and a speed of the picker 102 moving through the field 112. In addition, the picker 104 has initiated a swath 122 in the field 112, and the picker 106 has initiated a swath 124. As shown, the swath 120 is next to (or adjacent) the swath 122, and the swath 122 is next to the swath 124. However, the swath 120 is not adjacent to the swath 124 (it is spaced apart from the swath 124). It should be appreciated that the pickers 102-106 may include or may be associated with or may make additional swaths in the field 112 and other fields, and also that other pickers may be active in harvesting the field 112. That said, it should be appreciated that a swath may have any desired size, constraint, definition, etc. For instance, and without limitation, a swath may represent movement of the picker 102 to harvest a single plant (e.g., one foot in length, etc.) or it may represent a particular length of movement by the planter 102, or a swath may include (or may be defined as) an entire pass across the field 112 by the picker 102 (e.g., where the pass may include a length in which the picker 102 is driven in the same direction up to where the picker 102 turns, etc.), etc.

While the detail shown in FIG. 1 is specific to the picker 102, it should be appreciated that each of the pickers 104 and 106 may also include the same components and may be consistently configured to capture and store both impact sensor data (in the illustrated embodiment) and location data as described herein (again, regardless of whether the pickers 104 and 106 are corn ear pickers, combine harvesters, or other harvesting machinery). As such, the description herein with regard to the picker 102, in connection with estimating, correcting, etc. yield data and removing measurement error from such yield data, should be understood to also apply to each of the pickers 104 and 106 (again, regardless of whether the pickers 104 and 106 are corn ear pickers, combine harvesters, or other harvesting machinery).

That said, in order for the picker 102 (and/or the sensor 116) to determine the actual yield for the corn being harvested from the field 112, the picker 102 (and/or the sensor 116), in this exemplary embodiment, is configured to determine the yield based on the electrical signals received from the sensor 116, through Equation (1).

$$\hat{Y} ( x , y ) = \frac{( K + δ ) [ S ( x , y ) + ɛ ]}{A} \qquad ( 1 )$$

In Equation (1), A is the area of the swath generated by the picker 102 (e.g., swath 120 as described above, etc.), K is the conversion factor for the picker 102 (e.g., from FIG. 2, etc.), S(x, y) is the electrical signal at location (x, y) in the field 112, and Ŷ(x, y) is the determined or calculated yield for the picker 102 at the given location (x, y) (and, thus, at the given electrical signal received from the sensor 116). Additionally, ε is representative of random error incurred during measurement of the corn flowing through the chute 113 of the picker 102 (by the sensor 116). In connection therewith, a measurement error in general may include two components: the random error (ε), which is caused by random events, and systematic error (δ), which is introduced by inaccuracy of the conversion factor (K) due to imperfect calibration of the picker 102 (e.g., lack of such calibration, improper calibration, etc.). This algorithm is developed to remove systematic error (δ) from yield data collected by pickers.

From time to time (e.g., for each instance (or picker instance or harvest instance) created by the picker 102 (e.g., a duration from when the picker 102 is started to when the picker 102 stops (e.g., from the start of a day to lunch, between times when the picker is recalibrated, from the start of a day to the end of a day, etc.), at a fixed or predetermined time, at the end of each hour, at the completion of picking the field 112, etc.), etc.), the picker 102 is configured to transmit, to the field engine 108 (broadly, a computing device as described more hereinafter), the determined yield data (as determined via Equation (1) by the sensor 116, the picker 102 via network communication with the sensor 116, etc.), the electrical signal data for the impact sensor 116, the area data for the swath 120 (and other swaths created by or performed by the picker 102) (i.e., calculated as a swath length by width as described above (e.g., based on the location data for the picker 102), etc.), and/or the location data for the GPS system 118. In this way, not only does the picker 102 (and/or the sensor 116) send the calculated yield data to the field engine 108, but it also sends the various inputs collected by the picker 102 and used to generate the yield data. With that said, it should be appreciated that in other embodiments, the field engine 108 may be configured to determine the yield for the corn being harvested from the field 112, by the picker 102 (instead of the picker 102 (or sensor 118) making such determination and providing it to the field engine 108), based on the data received from the picker 102 (and, potentially, also based on Equation (1)).

It should be appreciated that scenarios may exist in which the area contributing to the total mass of a field is not sufficiently covered by the spatial yield data. Circumstances such as data loss or pickers without yield monitors create a discrepancy between the total harvested area in a field and a sum of the estimated areas of each data point in the yield data. For instance, in an example survey of 727 existing fields, more than 200 had approximately 50% “missing” data. In connection therewith, the systems and methods herein may be configured to compensate for the prevalence of missing data. For instance, the average yield of the missing areas may be approximated by projecting the distribution of known areas across the unknown areas. In this manner, the systems and methods herein may decrease the distortion associated with such missing data in fields with single or multiple picker instances. What's more, further spatial modelling of yield across the unknown areas may be utilized, leveraging picker operating specifications, historical yield, environmental data and other spatial factors.

In any case, once the data is received from the picker 102 and/or the sensor 116 (and any necessary yield calculations are performed thereby and/or by the field engine 108), the field engine 108 is configured, in turn, to store the data or part of the data received from the picker 102 in a data structure included in memory therein. In particular, as shown in Table 1, the yield data from the picker 102 (for its part in the harvest of field 112) is stored along with the location data of the picker 102 associated with the given yield data, the identity of the picker 102, the identity of the field 112, and data for the given swath formed by the picker 102 in the field 112. Similar data is also stored for each of the other pickers 104 and 106 (based on their role in the harvest of field 112) (regardless of whether they are corn ear pickers, combine harvesters, or other harvesting machinery). It should be appreciated that the data in Table 1 is exemplary in nature and is for only a portion of the field 112, and that additional entries would be provided from each of the pickers 102-106 to represent the entire field 112 (and additional swaths in the field).

TABLE 1

| | | | | Swath | Swath | |
|---|---|---|---|---|---|---|
| | | | | Width | Length | Yield Mass |
| Picker | Field | Longitude | Latitude | (ft) | (ft) | (wet) (lb/ac) |
| 102 | 112 | −93.426463 | 42.0567176 | 20 | 7.929 | 2,674.1 |
| 104 | 112 | −93.425489 | 42.0594334 | 17 | 6.507 | 5,694.8 |
| 106 | 112 | −93.425479 | 42.0595901 | 15 | 7.856 | 13,399 |
| 102 | . . . | . . . | . . . | . . . | . . . | . . . |

As described above, in various embodiments, the field engine 108 may be configured to determine the yield of the harvest for the pickers 102-106 (instead of the pickers 102-106 (or the corresponding sensor 116) performing the calculation), whereby the error (e.g., the systematic error (δ) in Equation (1), etc.) may further be eliminated and/or limited with a sufficient dataset from the different pickers 102-106. In particular, a normalization factor may be determined for a given one of the pickers 102-106 and/or for a given data set from one of the pickers 102-106, whereby even the systematic error associated with the above-described calibration scenarios may be reduced, limited or completely eliminated.

In such embodiments, and with reference to Equation (1), the systematic error (δ) can be eliminated, for example, through use of average of yield estimates over a dataset associated with swaths of sufficient sample sizes received from the pickers 102-106 (e.g., where a number of samples (ns) in the swath (e.g., electrical signals recorded for the swath, etc.) is greater than 30, where the swath has a length of at least about 50 feet, where at least 30 stalks of corn are arranged in at least three rows over the length of the swath, and/or where the picker 102 moves between 2 miles per hour and 8 miles per hour during picking operation of the swath; etc.). In general, the dataset may include data points in a column (or swath) of the field 112 picked, for example, by the picker 102. The systematic error (δ) is eliminated, then, from Equation (1), through application of Equations (2)-(4).

$$\begin{matrix}\overline{Y} = K \overline{S} \\ where , & ( 2 ) \\ \overline{Y} = \frac{{\sum }_{d a t a s e t} \hat{Y} ( x , y )}{n s} & ( 3 ) \\ \overline{S} = \frac{{\sum }_{d a t a s e {t}^{\frac{S ( x , y )}{A}}}}{n s} & ( 4 )\end{matrix}$$

The above equations (Equations (2)-(4)), and the corresponding normalization calculations herein, more generally, are based on an assumption that crops tend to produce similar yields in adjacent locations (e.g., in adjacent swaths or columns produced by one or more of the pickers 102-106, etc.), with the variations between them increasing with distance. For the field 112, for example, the swath 120 and 122, being adjacent to one another, will generally include the same (or similar) yield, as compared to swathes 120 and 124 which are not adjacent (i.e., which are increased in distance apart). In this manner, for yield data in two given swaths (i and j) (e.g., swaths 120 and 122, etc.) (or, potentially, in two given passes of a planter across a field), the average true yields for the two swaths (or passes) can be expressed using Equations (5) and (6) as a basis for determining the average electrical signal value (where the electrical signals received from the pickers 102 and 104 are used to represent true yields, as they represent true values not biased by the calibration process).

$$\begin{matrix}{\overline{S}}_{i} = {\overline{S}}_{j} + ϕ ( {d}_{i j} ) & ( 5 ) \\ {lim}_{{d}_{ij} \to 0} ϕ = 0 & ( 6 )\end{matrix}$$

In Equations (5) and (6), φ is a variation between the average true yields in the two columns or swaths (i and j) and dᵢⱼ represents a distance between the two columns or swaths (i and j). In the above, the variation (φ) between the average true yields approaches zero when the distance between the two columns (dᵢⱼ) also approaches zero (i.e., such that the two columns or swaths essentially become the same column or swath). That is, where the distance is zero, the average true yields of the two columns or swaths are the same. That said, it should be appreciated that were the data resolution for a single row is sufficient, it may similarly be used to determine such an average within the single row.

Additionally, where the two columns (or swaths) (i and j) are harvested by two different pickers, such as, for example, picker 102 and 104, having response curves (e.g., well-calibrated response curves, etc.) with slopes Kᵢ (for picker 102) and Kⱼ (for picker 104), the average yield estimates for each of the pickers 102 for columns i and j (e.g., swaths 120 and 122, etc.), respectively, can be expressed by Equations (7) and (8) (taking into account Equations (5) and (6)).

Y̅ᵢ=KᵢS̅ᵢ (7)

Y̅ⱼ=KⱼS̅ⱼ (8)

As indicated above, a lesser variation in yield average occurs between two neighboring columns or swaths (based on the assumption that adjacent columns (or swaths) have limited variation because of their proximity), for example, swaths 120 and 122. Where such an assumption is permitted (as it is herein), that the variation between the adjacent swaths is within an acceptable tolerance range, Equations (9), (10), and (11) are then provided to calculate the yield average. It should be appreciated that such neighboring swaths may be formed by two different pickers, or they may be formed by two different picker instances for the same picker.

Y̅_{nbi}=KᵢS̅_{nbi} (9)

Y̅_{nbj}=KⱼS̅_{nbj} (10)

S̅_{nbi}=S̅_{nbj} (11)

In Equations (9), (10), and (11), S̅_{nbi} is the average of electrical signals (as a basis for representing the true yield for swath i) received in one of the neighboring (nb) columns that is harvested by picker 102 (column i, for example), and S̅_{nbj} is the average of electrical signals (as a basis for representing the true yield for swath j and free of calibration error) received in the other one of the neighboring columns that is harvested by picker 104 (column j, for example). Consequently, the data points in the neighboring paths of the two different pickers 102 and 104 are extracted (for the data structure associated with the field engine 108), and then the yield data estimated by picker 104 is normalized to that of the picker 102 using a normalization factor (nfᵢⱼ), as defined by Equations (12) and (13).

$$\begin{matrix}n {f}_{i j} = \frac{{K}_{i}}{{K}_{j}} = \frac{{\overline{Y}}_{n b i}}{{\overline{Y}}_{n b j}} , i \neq j & ( 12 ) \\ n {f}_{i j} = 1 , i = j & ( 13 )\end{matrix}$$

Moreover, the normalization factor determines the relative yield estimates of picker 104 for column j, for example, to picker 102 for column i. Regardless of which picker 102, 104 is selected as the basis for the normalization, the absolute value of the normalized yield for the field 112 is then determined based on the corresponding truckload of the field 112. And, in particular in this example, it is calculated using a scaling factor (sfᵢ) as provided in Equation (14).

$$s {f}_{i} = \frac{truckload}{{\sum }_{j = 1}^{n} {\sum }_{x , y} n {f}_{i j} {Y}_{j} ( x , y ) {A}_{j} ( x , y )} \qquad ( 14 )$$

Here, Yⱼ(x, y) is a yield data point (in mass of grain yield per unit area) collected by the picker 104 (for column j, for example) at location (x, y) in the field 112. And, Aⱼ(x, y) is the area associated with the data point Yⱼ(x, y) in estimating the yield data point value, calculated as a swath width multiplied by a distance moved by the picker 104 for the given data point.

Taking into account the above, the field engine 108 is configured to then calculate the normalized yield for the field 112, from pickers 102 and 104 for each of the swaths i and j, based on Equations (15) and (16).

norm_yldⱼ(x,y)=(nfᵢⱼ×sfᵢ)Ŷⱼ(x,y) (15)

norm_yldᵢ(x,y)=(sfᵢ)Ŷᵢ(x,y) (16)

With the equations above, in the system 100, the field engine 108 is configured to normalize yield data from each of the pickers 102-106. In particular, the field engine 108 is configured to read in data from the picker 102 (e.g., as received from the picker 102 or the corresponding sensor 116 in the manner described above, etc.). The data may be included in a variety of different formats. For example, the data may be included in a data structure transmitted to the field engine 108 or the data itself may simply be transmitted. In either case, the data may include the field name and harvest year (in addition to the other information described above). Based further on this data, the field engine 108 is configured to calculate a truckload yield measurement, by weight, based on the data from the picker 102 as retrieved from the data structure (which may also include the truckload mass for the given field and harvest year).

That said, in determining whether to normalize the yield data from the pickers 102-106 as described above, the field engine 108 is also configured to calculate the mass of the crop harvested from the field 112 based on the yield calculated by the picker(s) 102-106, a swath width for the swaths 120-124, and a distance traveled by the pickers 102-106 in making the swaths to harvest the field 112 (for each of the collected data points from the field 112). This is expressed in Equation (17).

$$Total mass = {\sum }_{i i = 1}^{n} ( swath {width}_{i i} \times d i s t a n c {e}_{i i} \times {\overline{Y}}_{i i} ) \qquad ( 17 )$$

Here, n is the total number of data points in the field 112, swath widthᵢᵢ is the swath width of data point ii, distanceᵢᵢ is the travel distance a picker travels in data point ii, and Ŷᵢᵢ is the estimated yield of data point ii from the picker.

In turn, the field engine 108 is configured to determine if the difference in the actual weighed mass of the harvest (based on the actual weight numbers for the truckload(s) at the weighing station) is within a threshold of the calculated mass of the harvest (e.g., within one percent, two percent, etc.). When the difference is within the threshold (or potentially equal to the threshold), the field engine 108 is configured to end the process and/or proceed to a next yield, whereby the mass is considered sufficiently close to avoid correction or normalization in the exemplary embodiment.

Conversely, when the difference exceeds (or potentially is equal to) the threshold, in this embodiment, the field engine 108 is configured to determine the number of pickers involved in the collection of the yield data upon which the mass was determined (e.g., three pickers 102-106 in the system 100, etc.). In connection therewith, when a single picker (such as picker 102) is employed, for instance, the field engine 108 is configured to calculate the scaling factor (sf) as described above with regard to Equation (14), based on the actual weighed mass and the calculated yield. The field engine 108 is configured to then update the yield data included in the data structure (e.g., in Table 1, etc.) for the picker 102, for example, based on the scaling factor.

When multiple pickers are employed (such as the three pickers 102-106 in the system 100), the field engine 108 is configured to identify neighboring data points between the multiple pickers and to access the neighboring data points. When the sample size of the neighboring data points between the pickers is less than a size threshold (e.g., 50 data points, 100 data points, etc.), the field engine 108 is configured to omit a normalization factor or designate the normalization factor as not applicable (or N/A). However, if there are sufficient neighboring data points (e.g., more than the size threshold of 50 data points, more than the size threshold of 100 data points, etc.), the field engine 108 is configured to calculate the mean yields for each of the multiple pickers 102-106 and identify a normalization factor for each pair of pickers (as described above in connection with Equations (12) and (13)). For instance, for the three pickers 102-106 in field 112, multiple normalization factors (nf's) may be populated into a matrix, as shown in Table 2, for each of the picker pairs. Each of the normalization factors is provided to normalize yield by one picker to another yield by another picker (even when the pickers are different types of pickers, such as an ear picker, a combine harvester, etc.). It should be appreciated that the normalization factor of one picker to itself will be 1 (as shown).

TABLE 2

| | Picker 102 | Picker 104 | Picker 106 |
|---|---|---|---|
| Picker 102 | 1 | nf_{104, 102} | nf_{106, 102} |
| Picker 104 | nf_{102, 104} | 1 | nf_{106, 104} |
| Picker 106 | nf_{102, 106} | nf_{104, 106} | 1 |

When there are not a sufficient number of neighboring points between two specific pickers (i.e., when the sample size of the neighboring data points between the pickers is less than a size threshold) (e.g., pickers 102 and 106 in FIG. 1, etc.), the normalization factor for this pair will be assigned with N/A. The normalization factor for this pair is then calculated based on other pairs where sufficient neighboring data points exist, using Equation 18 (e.g., an intermediate picker may be employed, etc.). In this manner, the field engine 108 may be configured to calculate a normalization factor for pickers 102 and 106 in the system 100, for example, based on a normalization factor for picker 102 and picker 104 and a normalization factor for picker 104 and picker 106, as expressed in Equation (18) (where i relates to picker 102, k relates to picker 104, and j relates to picker 106).

$$n {f}_{i j} = \frac{{K}_{i}}{{K}_{j}} = \frac{{K}_{i}}{{K}_{k}} \frac{{K}_{k}}{{K}_{j}} = n {f}_{i k} n {f}_{k j} \qquad ( 18 )$$

Alternatively, the common picker for field data may be selected based on normalization of the data from the field (or picker instances). For example, as shown in FIG. 1, the picker 104 includes adjacent swaths with both the pickers 102 and 106, whereby normalizing the yield data to the picker 104 may permit an intermediate picker to be omitted as a manner of normalization.

When a normalization factor is available for all picker pairs, the field engine 108 is configured to calculate a scaling factor using Equation (14), relying of the normalization factors for the specific pickers and the corresponding data for the pickers, as included in Table 2. The field engine 108 is configured to then normalize and update the yield data in the data structure (e.g., in Table 1, etc.) for the pickers 102-106 based on the scaling factor, as defined in Equations (15) and (16).

It should be appreciated that despite three pickers being included in the field 112 in the system 100, a different number of pickers (or picker instances) may be included in the harvesting of other fields, whereby the above description would be applicable and adapted to that number of pickers (or picker instances).

FIG. 3 illustrates an exemplary computing device 300 that can be used in the system 100. The computing device 300 may include, for example, one or more servers, workstations, personal computers, laptops, tablets, smartphones, PDAs, etc. In addition, the computing device 300 may include a single computing device, or it may include multiple computing devices located in close proximity or distributed over a geographic region, so long as the computing devices are specifically configured to function as described herein. In the exemplary embodiment of FIG. 1, each of the pickers 102-106, the sensor 116, and the field engine 108 is implemented in a computing device consistent with the computing device 300. With that said, the system 100 should not be considered to be limited to the computing device 300, as described below, as different computing devices and/or arrangements of computing devices may be used. In addition, different components and/or arrangements of components may be used in other computing devices.

Referring to FIG. 3, the exemplary computing device 300 includes a processor 302 and a memory 304 coupled to the processor 302. The processor 302 may include one or more processing units (e.g., in a multi-core configuration, etc.). For example, the processor 302 may include, without limitation, one or more processing units such as a central processing unit (CPU), a microcontroller, a reduced instruction set computer (RISC) processor, an application specific integrated circuit (ASIC), a programmable logic device (PLD), a gate array, and/or any other circuit or processor capable of the functions described herein (alone or in combination).

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may include one or more data structures (e.g., data structure 403, etc.) and may be configured to store, without limitation, yield data, location data, scaling factors, normalization factors, data relating to pickers used to harvest crops, and/or other types of data suitable for use as described herein.

Furthermore, in various embodiments, computer-executable instructions may be stored in the memory 304 for execution by the processor 302 to cause the processor 302 to perform one or more of the functions described herein (e.g., in the method 400, etc.), such that the memory 304 is a physical, tangible, and non-transitory computer readable storage media. Such instructions often improve the efficiencies and/or performance of the processor 302 that is operating as described herein (e.g., performing one or more of the operations of the method 400, etc.) whereby upon such performance of the one or more functions, the computing device 200 may be considered (or transformed into) a unique, special purpose device. It should be appreciated that the memory 304 may include a variety of different memories, each implemented in one or more of the functions or processes described herein.

In addition, the illustrated computing device 300 also includes a network interface 306 coupled to the processor 302 and the memory 304. The network interface 306 may include, without limitation, a wired network adapter, a wireless network adapter, a mobile network adapter (e.g., an NFC adapter, a Bluetooth adapter, etc.), or other device capable of communicating to one or more different networks, including, for example, the network 110. Further, in some exemplary embodiments, the computing device 300 may include the processor 302 and one or more network interfaces incorporated into or with the processor 302.

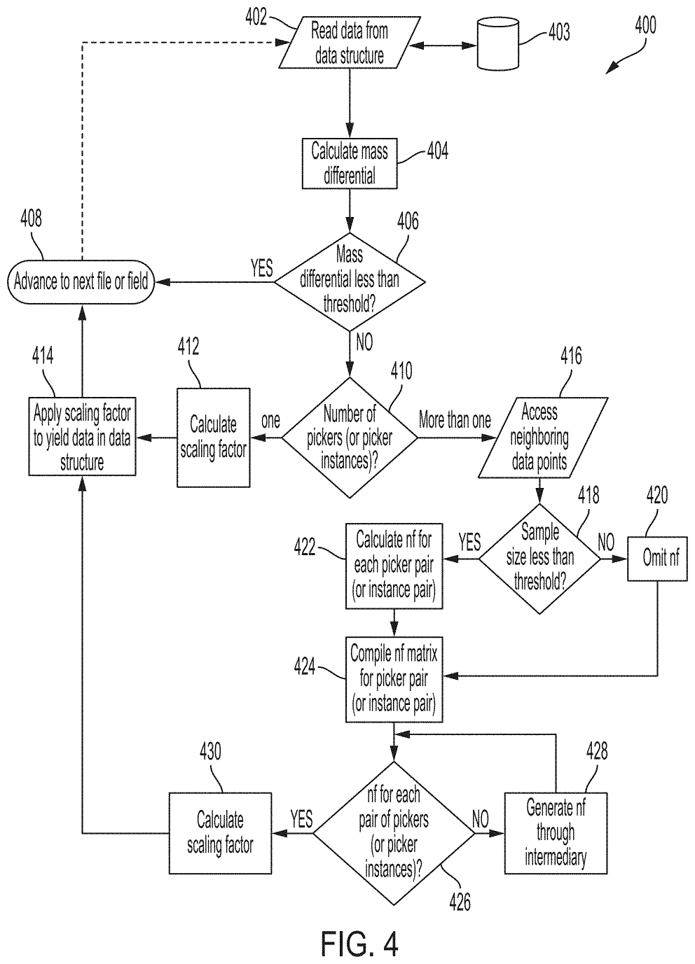

FIG. 4 illustrates an exemplary method 400 for determining, from data for a given picker (and potentially from data for other pickers) (e.g., for an ear picker, a combine, another harvesting machine, etc.), a yield of crops of a field harvested by the picker (and, potentially, the other pickers). The exemplary method 400 is described with reference to FIG. 1 as implemented in the field engine 108 and based on data from the pickers 102-106 from harvesting the field 112, and also with reference to the computing device 300. However, it should be understood that the methods herein are not limited to the exemplary system 100 or the exemplary computing device 300. Likewise, the systems and the computing devices herein should not be understood to be limited to the exemplary method 400.

At the outset in the method 400, after a harvest of field 112 is completed, by each of the pickers 102-106, the field engine 108 accesses, at 402, data from a data structure 403 (e.g., including the data structure shown in Table 1, etc.) (e.g., in memory 304 associated with the field engine 108, in memory 304 associated with the pickers 102-106, in other memory 304, etc.), associated with various aspects of the field 112, the pickers 102-106, the harvested corn, etc. In connection therewith, the data may include, without limitation, a field identifier for the field 112, a picker identifier (e.g., for one or more of pickers 102-106, etc.), location data for the pickers 102-106, truck weight(s) of corn associated with the total harvested yield of the field 112, electrical signal data from the sensor 116 (for each of the pickers 102-106), temporal data (e.g., a time stamp associated with the various collected data, etc.), flow data for the corn through the pickers 102-106 (e.g., mass per second, etc.), etc. In general, the data is accessed per field (e.g., whereby the operations described herein are performed on a field by field basis, etc.), but could also be accessed per file or series of files to achieve the same. But when the data pertains to more than one field, the data for the field 112, for example, is processed according to method 400, while data for other fields may or may not be separated therefrom and/or subject to a repeat of the method 400.

What's more, while referring to the field per picker as the unit of data to be included in the method 400, more generally, the method 400 relies on the assumption that yield from the selected neighboring yield data points are collected under the same operational or management practices. The differences between the neighboring yield data are driven by the systematic calibration error described earlier. In field and harvest operations, other factors may contribute to the differences as well. In this case, a pre-processing step or operation may be utilized to assure the assumption is valid. In connection therewith, the pre-processing may be set to eliminate the differences caused by other managerial and operational factors (e.g., the same picker that collect yield data of the same field but on different dates, fields that are planted with different products (some with particular traits, and some without), portions of fields being irrigated or applied with pesticide, or experimental fields where multiple treatments are applied, etc.). For example, where a picker starts and stops picking in the field 112, while continuously picking, the data from the field 112 and the picker will form a single instance (or picker instance or harvest instance, etc.) (where each instance may then be associated with a swath). When the picker stops for lunch, or is stopped at the end of the day and restarts, it may be treated as separate “pickers” in the context of the method 400, because a calibration factor may be adjusted during a lunch break, whereby the data prior to the lunch break and after the lunch break are shown to be separate in the method 400, as a different normalization is likely to apply. As such, a single picker may have multiple picker instances within a field whereby a separate normalization may be necessary per picker instance (i.e., separate picker instances are generally treated as separate pickers even if they literally relate to the same picker). In this manner, the pre-processing step/operation assures the method 400 accounts for changes in the picker between different picker instances. What's more, it should be appreciated that picker instances may include and/or relate to more than time. For example, a picker instance may include a combination of a picker and other factors, such as (without limitation) time, management operations (e.g., irrigated or non-irrigated fields, etc.), genetics (e.g., sterile and fertile, etc.), environment (e.g., fertilized or not, etc.), etc. In this manner, the method 400 also helps ensure that any differences between two groups of pickers is caused by calibration error, and not by other factors such as management, or genotype, etc.

It should also be appreciated that for the specific field 112, for example, or for a particular one of the pickers 102-106, the accessed data may include a weighed mass of the crop (e.g., corn in the above example, etc.) harvested from the field by the given picker (or pickers) based on a weighing operation performed for the field 112 and/or the pickers 102-106 after the harvest was completed (e.g., trucks containing the harvested crop from the field 112 may be weighed at a weighing station, etc.). The weighed mass may be specific to the field 112, or to a truckload which was harvested from the field 112 (and converted as necessary or desired to a field basis, etc.), or for a portion of the field 112 harvested. This mass is linked to the field 112 and/or area of the harvest and may be expressed as desired, for example, as pounds per acre (lbs/ac), kilograms per hectare (kg/ha), etc.

Once the desired data is accessed, the field engine 108 calculates, at 404, a mass differential between the actual weighed mass of harvested corn and the calculated yield mass of the field 112. Specifically, a yield mass of the field 112 is calculated according to Equation (17). With that said, it should be appreciated that the yield relied on in this equation is determined based on the electrical signals received from the pickers 102-106 as the field 112 was harvested. With the yield mass calculated, the mass differential is calculated as the yield mass less the weighed mass divided by the weighed mass (or the absolute value thereof). It should be appreciated that the mass differential may be determined otherwise in other embodiments, as long as the mass differential quantifies some difference between the actual weighed mass of the harvested crop and the calculated yield mass.

The field engine 108 then determines, at 406, whether the mass differential is above or below a defined threshold. Here, the threshold is 1% and the field engine 108 determines whether the mass differential is below the 1% threshold. That said, it should be appreciated that the threshold may be another percentage or other number in other embodiments (e.g., about 0.5%, about 2%, about 3%, etc.). When the mass differential is below the defined threshold, the field engine 108 advances, at 408, to the next field or file for evaluation (and returns to step 402). In short, by the calculated mass differential being less than the defined threshold, the method 400 assumes the yield data is accurate, within an acceptable variance, and no normalization is necessary.

However, when the field engine 108 determines that the mass differential is above the defined threshold (at 406), the field engine 108 determines, at 410, how many pickers (or picker instances) participated in the harvest of field 112. For example, from the data included in the data structure 403 (e.g., including the exemplary data included in Table 1, etc.), the calculated total yield mass for the field 112 may be 1,238,195 lbs/ac and the actual weighed mass for the harvested corn from the field 112 may include 1,032,880 lbs/ac, whereby the mass differential between the two values is about 19.9% (i.e., ((1,238,195−1,032,880)/1,032,880)*100). Because the mass differential is greater than 1%, in this example, the field engine 108 proceeds in the method 400 to operation 410 (to determine how many pickers participated in the harvest of the field 112) for purposes of normalization.

In connection therewith, at 410, if the field engine 108 determines that there is only one picker in the field 112 effecting the harvest (or more broadly, one picker instance), the field engine 108 calculates, at 412, a scaling factor as a ratio of the weighed mass and the calculated yield mass. And, the scaling factor is then applied, at 414, to the calculated yield data for the one picker included in the data structure 403, whereby the yield data is normalized and restored (or otherwise included) in the data structure 403 for use in further processing related to the harvested crop or seed, grain, etc. development based thereon. For instance, in the above example, where the calculated total yield mass for the field 112 is 1,238,195 lbs/ac and the actual weighed mass for the harvested corn from the field 112 is 1,032,880 lbs/ac, and where only one picker operated in harvesting the field 112, the scaling factor may be calculated as 0.83 (i.e., 1,032,880/1,238,195). The normalized yield data may then be 1,032,880 lbs/ac (i.e., 0.83*1,238,195).

However, if the field engine 108 determines that there is more than one picker (e.g., that there are the three pickers 102-106, or more than one picker instance in the field 112, etc. as in the above example) involved in harvesting the field 112, the field engine 108 accesses, at 416, neighboring data points for the pickers 102-106 (for the different picker instances, for example, where one picker is involved, etc.). As shown in FIG. 1, neighboring data points between picker 102 and picker 104 include, for example, data points within a region that extends from point A to point B (between swaths 120 and 122). And, neighboring data points between picker 104 and picker 106 include, for example, data points within a region that extends from point C to point D (between swaths 122 and 124). Both regions have in excess of 100 data points. That said, it should be appreciated that there are no neighboring data points between picker 102 and picker 106.

Next in the method 400, the field engine 108 determines how many neighboring data points exist for two pickers. In connection therewith, if the field engine 108 determines, at 418, that there is less than (or the same as) a size threshold of neighboring data points for two pickers (e.g., 50 data points, 100 data points, 200 data points, etc.), the field engine 108 omits determining a direct normalization factor (nf) for the picker pair, at 420. Conversely, when the field engine 108 determines, at 418, that there is more than the size threshold of neighboring data points, the field engine 108 calculates, at 422, a normalization factor (nf) for the picker pair, based on the mean of the of the yields for the neighboring data points. In the field 112 of FIG. 1, for example, the pickers 102 and 106 include no neighboring data points. As such, the field engine 108 omits a direct normalization factor for that picker pair. However, because sufficient neighboring data points exit for the pickers 102 and 104 and also for pickers 104 and 106, the field engine 108 calculates two normalization factors (i.e., nf_{102,104} and nf_{104,106}) (e.g., based on Equation (12), etc.). Specifically, based on the data included in the data structure 403, for the swaths 120-124, the normalization factors nf_{102,104} and nf_{104,106} may be determined, for example, to be 1.29 and 0.58, respectively. In so doing, the field engine 108 may calculate the normalization factor of picker 102 relative to picker 104, and also calculate the normalization of picker 104 relative to picker 102 (see, Table 3). That said, it should be appreciated that the normalization factors may be determined in different manners in other embodiments.

When the normalization factors are calculated or otherwise determined, the field engine 108 compiles, at 424, a normalization factor matrix for the pickers 102-106 of the field 112 (see, e.g., Table 2, etc.). Table 3 illustrates an example normalization factor matrix for the field 112 and the pickers 102-106. It should be appreciated that the actual values for the normalization factors included in the matrix of Table 3 are exemplary in nature and are based on the particular underlying numeric values for the pickers 102-106 (e.g., yield data, etc.). As such, as the underlying numeric values change, so would the corresponding normalization factors. However, the calculation is still consistent with that described above in the method 400 and in the system 100 (e.g., in applying Equation (12) and Equation (18), etc.).

TABLE 3

| | Picker 102 | Picker 104 | Picker 106 |
|---|---|---|---|
| Picker 102 | 1 | 1.29 | 0.81 |
| Picker 104 | 0.77 | 1 | 0.58 |
| Picker 106 | 1.2 | 1.71 | 1 |

Then, the field engine 108 determine, at 426, whether each picker pair in the matrix includes a normalization factor. As indicated above, normalization factors for the picker pair of picker 102 and 106 may initially be omitted based on a lack of neighboring data points (as determined at operation 420). As such, in order to determine the missing normalization factors for this picker pair, the field engine 108 generates, at 428, the normalization factor through an intermediary. Specifically, picker 104 includes more than 100 neighboring data points to each of pickers 102 and 106. As such, a normalization factor for pickers 102 and 106 is determined based on a multiplication of the normalization factor for each of the pickers 102 and 106 relative to the picker 104. This is expressed in Equation (18). In so doing, then, in the above example, the normalization factors nf_{102,106} and nf_{106,102} for pickers 102 and 106 may be calculated as 0.81 and 1.2. Notwithstanding the above, it should be appreciated that in some embodiments where insufficient neighboring data points exist for a pair of pickers, a normalization factor may be omitted from the matrix all together and not estimated by reliance on an intermediate picker. In these embodiments, the field engine 108 may omit scaling for the associated yield data all together.

Finally in the method 400, once the missing normalization factors are generated and updated in the normalization factor matrix, the field engine 108 determines, at 426, that the matrix includes a normalization factor for each pair of pickers. Then, at 430, the field engine 108 calculates a scaling factor consistent with the Equation (14), whereby the actual weighed mass is divided by the normalized yield mass (e.g., as obtained from the data structure 403, etc.). In this example, the scaling factor may be calculated to be about 0.83. With the scaling factor, the field engine 108 applies, at 414, the scaling factor to the calculated yield data based on Equations (15) and (16) to provide normalized yield data. The normalized yield data is stored in the data structure 403 and the field engine 108 proceeds to the next field or file.

It should be appreciated that in one or more embodiments, a conversion may be implemented, by the field engine 108, to convert dry mass to wet mass or vice-versa (for yield). In connection therewith, the field engine 108 may calculate the dry mass from the wet mass based on Equation (19), where the moisture rate equals 100% less the standard moisture percentage (e.g., 14% in this example), etc. It should be appreciated that such a conversion is optional herein, and may be performed all or may be performed in selected exemplary embodiments.

$$Dry Mass = Wet Mass \times \frac{100 - Moisture}{Moisture rate} \qquad ( 19 )$$

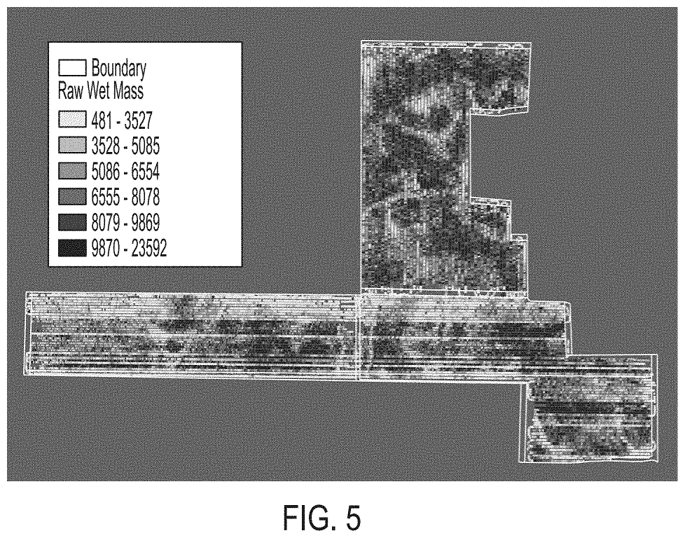

In addition to storing the normalized yield data in the data structure, the data may also be output (e.g., visually, etc.) to a user associated with harvesting the field 112, etc. at a computing device (e.g., the computing device 300, etc.). In this way, the user may have or may be provided an interface of yield in the field 112 at any desired time. Further, in various embodiments, the normalized yield data may be provided to the user in real time or near-real time. That said, FIG. 5 illustrates an example yield map that may be displayed to a user associated with harvesting a field 512, where differences in normalized yield are visually displayed for different areas of the field 512.

### EXAMPLE

In one example, the above operations of the field engine 108 were evaluated using synthetic fields. The synthetic fields were generated based on the yield data of ten real single-picker fields. They were then normalized to their corresponding truckloads, and the normalized fields served as true values in the evaluation of the field engine 108. Before normalization, though, systematic and random errors were introduced into random locations of the harvesting data (e.g., into the pass numbers for the pickers, etc.). Systematic errors were randomly drawn from a pool containing the ratios of truckloads over total yield masses for all the single-picker fields (see, FIG. 7). Each of the ten fields generated ten realizations of synthetic fields. And, these synthetic fields were normalized by the field engine 108. The extent of error over a field before and after normalization was evaluated using the Root Mean Square Error (RMSE) method, in accordance with Equation (20).

$$R M SE {=}^{\sqrt{\frac{{\sum }_{i i = 1}^{n} {( {\hat{y}}_{i i} - {y}_{i i} )}^{2}}{n}}} \qquad ( 20 )$$

In Equation (20), ŷᵢᵢ is the yield estimate at data point ii, ŷᵢᵢ is the true value of yield at data point ii, and n is the total number of data points of the field.

Single Picker Field

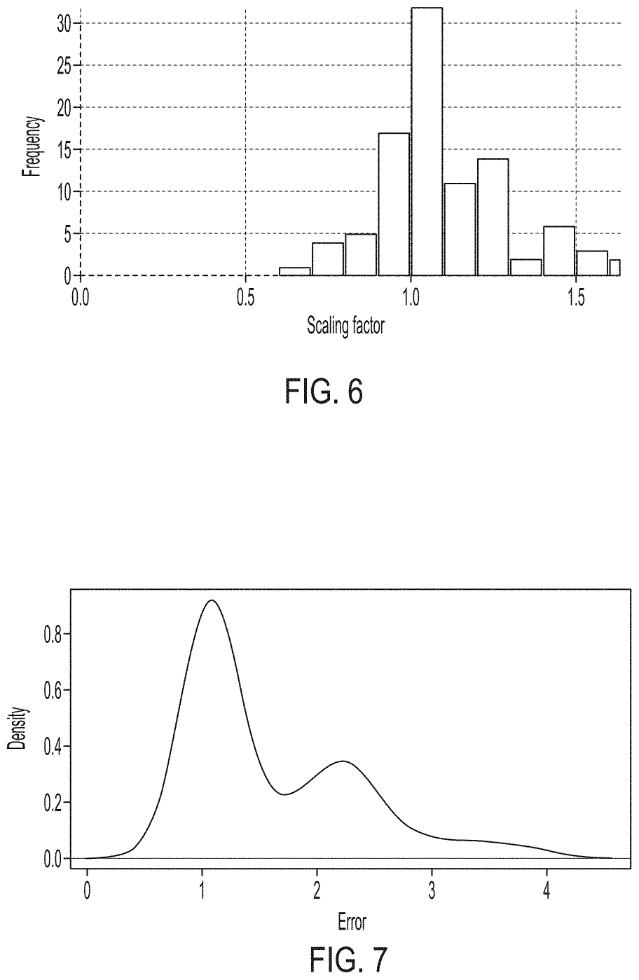

In connection therewith, yield data for a single-picker field was scaled to its total mass equal to a truckload of the harvested crop, while the relative yield values within the field remained the same. The scaling factors, in this application, are shown in FIG. 6. As shown, the scaling factors ranged from about 0.68 to about 1.63, with a mean of about 1.1.

Two-Picker Field

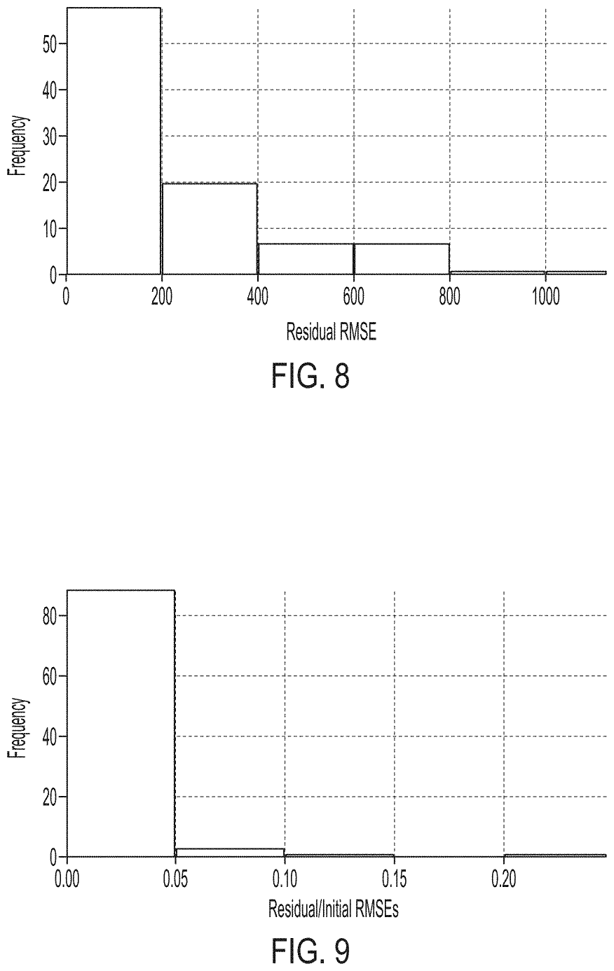

Performance of the field engine 108 with regard to a two-picker field was also evaluated in accordance with the above synthetic fields. The synthetic fields were generated based on ten normalized single-picker fields. The fields were divided into two picker fields by randomly assigning picker paths to the two pickers. And errors, randomly drawn from an error pool (see, again, FIG. 7), were again introduced into each of the picker fields. The extent of error over a field was measured using the RMSE method in accordance with Equation (20). Each field produced ten realizations, leading to a total of 100 realizations of synthetic fields. The fields were then normalized by the field engine 108 in accordance with the present disclosure. After normalization, the extent of error was measured again using the RMSE method, and is referred to herein as residual RMSE. As shown in FIG. 8, the residual RMSE's are less than 1,100 lb/ac, while in more than 50% of the realizations the RMSE's were below 200 lb/ac. For more than 80% of the realizations, more than 95% of the error (see, FIG. 9) was removed from the fields by the normalization operations herein.

Three-Picker Field

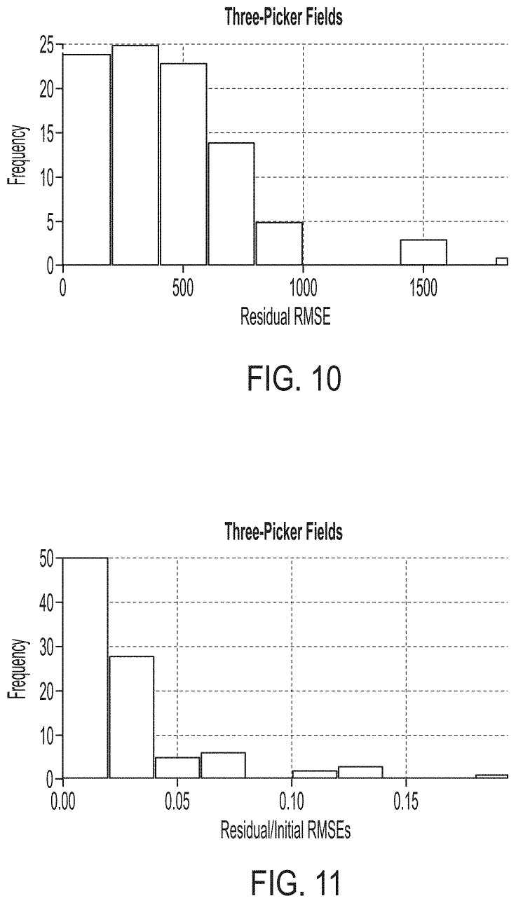

Performance of the field engine 108 with regard to a three-picker field was also evaluated in accordance with the above synthetic fields, in a similar manner to that described for the two-picker fields. The same ten normalized single-picker fields were used, and the fields were divided into three picker fields by randomly assigning picker paths to the three pickers. The majority of the residual errors (see, FIG. 10) were below 1,000 lb/ac. Similarly, the field engine 108 removed more than 95% of the error (see, FIG. 11) in approximately 80% of three-picker field realizations.

N-Picker Field (Where N is Greater than Three)

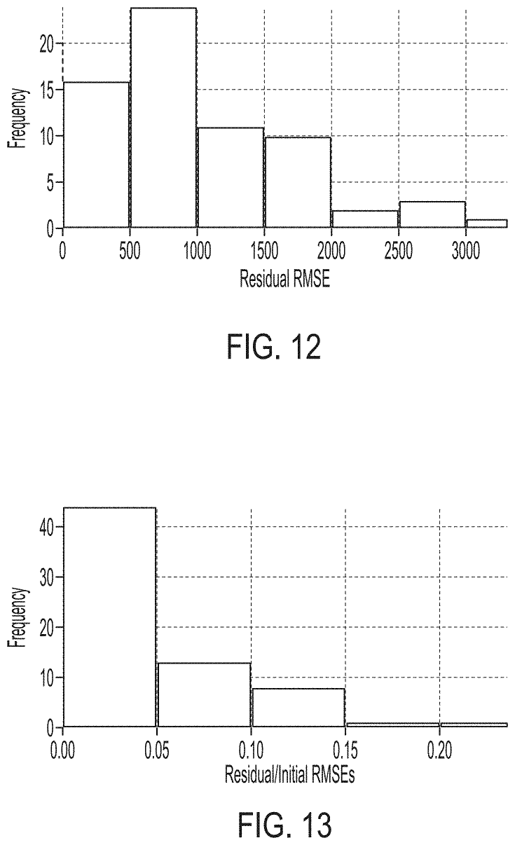

Performance of the field engine 108 with regard to a field having more than three pickers (i.e., a N-picker field) was also evaluated in accordance with the above synthetic fields. In so doing ,the number of pickers (n>3), locations of picker fields, and the magnitude of errors (see, again, FIG. 7) were randomly assigned. Similar to the two- and three-picker cases, 100 realizations of N-picker fields were generated. As shown in FIG. 12, the residual errors were greater than those in two-, and three-picker fields. This may be the result of more errors associated in these fields and normalization of such fields is more complex (in view of the additional pickers, etc.). Here, normalization was based on the proximity of average yields in two neighboring columns or swaths formed by the pickers. When neighboring data for multiple pairs of pickers was used in the normalization, error associated with each pair propagates to the final normalized field, leading to an increased RMSE compared to fields with fewer pickers. But, even then, when the error is presented as a ratio to the initial error, as in FIG. 13, the overall performance of the field engine 108 remained at a high level: over 95% of the error was removed in 67% of the realizations, and more than 75% of the errors for all the realizations.

Application

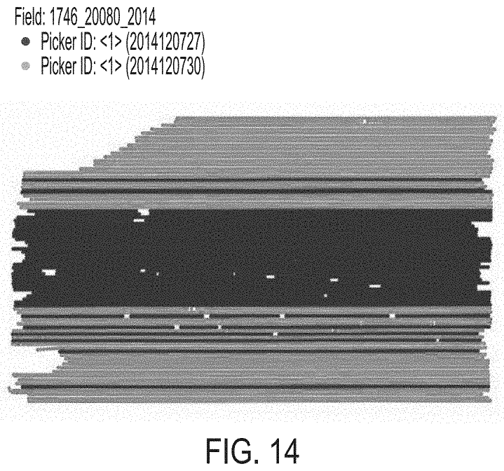

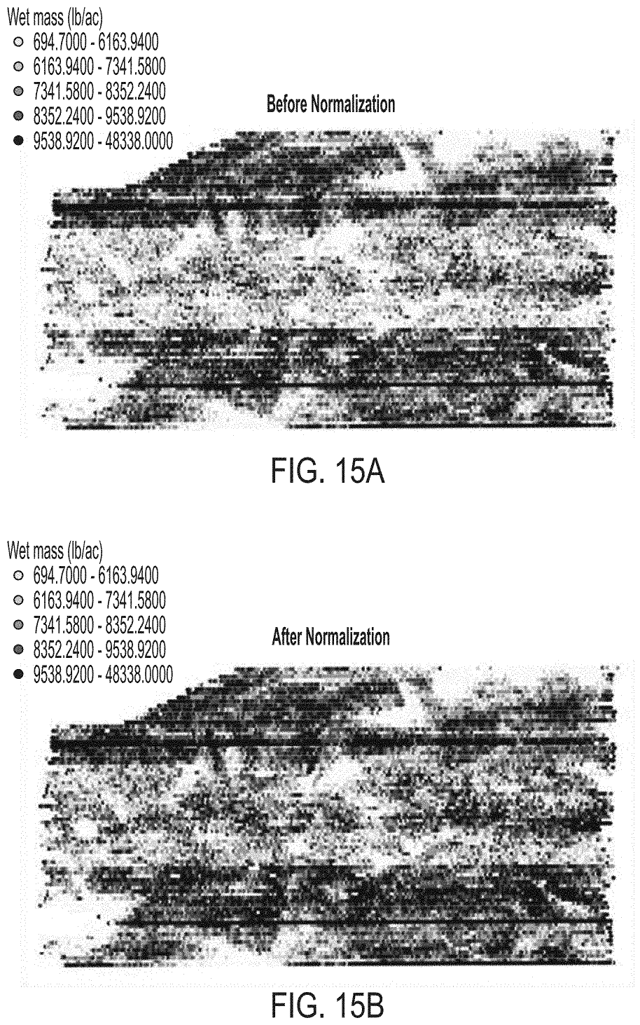

In one application, the field engine 108 was used for all 640 field-year combinations of data (data files). Here, field “ABC-123” was selected from the data files for purpose of demonstration. This field was harvested by two pickers with picker IDs of 1 and 2, respectively. Areas of field ABC-123 harvested by the two different pickers are shown in FIG. 14. And, the spatial yields in this field ABC-123, before and after normalization, are shown in FIGS. 15A and 15B. A comparison of FIGS. 15A and 15B shows that, in the before normalization image, a “low-yield” zone “coincidently” overlaps the picker route of picker 1 (e.g., as a result of an underestimation of yield by the picker 1, an overestimation of yield by the other picker 1, a combination thereof, etc.). After normalization, the difference of yield in the areas harvested by the different pickers 1, 2 significantly decreases, and the low- or high-yield patterns are less similar to the shape of picker routes.

The performance of the field engine 108 (e.g., exemplified as a computing device having an Intel Core i7-4600M CPU at 2.90 GHz, etc.) is shown in Table 4 for normalization of yield data for 640 fields. In connection therewith, the normalization operations took about 11.7 minutes, averaging about 1.09 second per field.

TABLE 4

| | | Time User | Time System | Time Elapsed |
|---|---|---|---|---|
| Input | Output | (sec) | (sec) | (sec) |
| 640 | 640 | 580.2 | 14.12 | 701.6 |

In view of the above, it should be appreciated that the systems and methods herein are capable of limiting, minimizing, or removing measurement errors typically present in yield data for fields harvested by two or more pickers (e.g., resulting from variations in calibrations between the pickers, etc.). Such improvement in yield data may be directly applicable to precision-based agriculture operations such as, for example, field management, crop management, nitrogen trials, remote sensing, image analysis, seed treatment, etc. In connection herewith, the final normalized yield values are generally independent of which picker is selected as the reference picker for the normalization, such that a prior knowledge of which picker being used in the field is better calibrated is not needed (or even relevant) to the results or performance of the embodiments herein.

In addition, it should also be appreciated that the systems and methods herein are applicable to any desired crop, including corn (as described above), soy bean, cotton, canola, wheat, etc. It should further be appreciated that the systems and methods herein may be applicable to a wide range of machinery for harvesting crops, including ear pickers, combines, etc. As such, reference herein to pickers should not be understood to be a limitation on the type of crop species being harvested or the type of harvesting machine being used to harvest the crop species (e.g., use of the term picker should not be considered as limiting the present disclosure to an ear picker or to corn unless specifically indicated, etc.). Moreover, the methods and systems herein may also be applied to other data, including environmental data (e.g., soil properties, temperature, and weather, etc.) used for environmental analysis, biological data used for product performance analysis, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof (e.g., to adjust or adopt or scale picker yield data collected at pickers to account for errors in calibration (where such adjustment may be performed or achieved at computing devices located away from the pickers, etc.), etc.), wherein the technical effect may be achieved by performing at least one of the following operations: (a) accessing data for a field harvested by at least one picker (e.g., an ear picker, a combine, another harvesting machine, etc.), wherein the accessed data includes yield data for the field received from of the at least one picker; (b) determining, by a computing device, a mass differential for a crop harvested by the at least one picker from the field; (c) when the mass differential exceeds a threshold: (i) calculating, by the computing device, a normalization factor for at least one pair of picker instances associated with the at least one picker; (ii) calculating, by the computing device, a scaling factor associated with one of the picker instances of the at least one pair of the picker instances based on the normalization factor; (iii) applying, by the computing device, the scaling factor to the yield data received from the at least one picker, such that the yield data is normalized; and (iv) storing, by the computing device, in a data structure, the normalized yield data; and (d) omitting a normalization factor for a pair of the picker instances, for data points of the picker instances in adjacent swaths formed by the picker instances in the field, when said pair of the picker instances includes less than the threshold number of neighboring data points within the accessed data.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) calculating a normalization factor for at least one pair of picker instances associated with at least one picker; (b) calculating a scaling factor associated with one of the picker instances of the at least one pair of picker instances based on the normalization factor; and (c) applying the scaling factor to the yield data received from the at least one picker, such that the yield data is normalized. In this manner, scaling may be utilized regardless of a mass differential, whereby detection of a mass differential may actually be omitted.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in adjusting picker yield data collected by pickers to account for errors in calibration, the method comprising:
accessing data for a field harvested by at least one picker, wherein the accessed data includes yield data for the field received from the at least one picker;
determining, by a computing device, a mass differential for a crop harvested by the at least one picker from the field; and
in response to the mass differential exceeding a threshold:
calculating, by the computing device, a normalization factor for at least one pair of picker instances associated with the at least one picker;
calculating, by the computing device, a scaling factor associated with one of the picker instances of the at least one pair of picker instances based on the normalization factor;
applying, by the computing device, the scaling factor to the yield data received from the at least one picker, such that the yield data is normalized; and
storing, by the computing device, in a data structure, the normalized yield data.

2. The computer-implemented method of claim 1, wherein calculating, by the computing device, the normalization factor includes calculating a normalization factor for each pair of the picker instances having at least a threshold number of neighboring data points within the accessed data, wherein the neighboring data points include data points for adjacent swaths in the field; and
wherein the method further comprises:
omitting a normalization factor for a pair of the picker instances, for data points of the picker instances in adjacent swaths formed by the at least one picker in the field, when said pair of the picker instances includes less than the threshold number of neighboring data points within the accessed data; and
calculating, by the computing device, a normalization factor for said pair of the picker instances that include less than the threshold number of neighboring data points within the accessed data based on an intermediary picker instance having at least a threshold number of neighboring data points within the accessed data with each of said pair of the picker instances.

3. The computer-implemented method of claim 2, wherein calculating a normalization factor for said pair of the picker instances that include less than the threshold number of neighboring data points within the accessed data includes:
calculating, by the computing device, a first intermediate normalization factor for a first one of said pair of the picker instances and the intermediary picker instance;
calculating, by the computing device, a second intermediate normalization factor for a second one of said pair of the picker instances and the intermediary picker instance; and
combining the first and second intermediate normalization factors to produce the normalization factor for said pair of the picker instances that include less than the threshold number of neighboring data points within the accessed data; and
wherein determining the mass differential for the crop includes calculating the mass differential as the yield mass based on accessed yield data less a weighed mass, divided by the weighed mass.

4. The computer-implemented method of claim 1, wherein calculating the scaling factor associated with one of the picker instances includes calculating the scaling factor based on the following algorithm:
$$s {f}_{i} = \frac{truckload}{{\sum }_{j = 1}^{n} {\sum }_{x , y} n {f}_{ij} {Y}_{j} ( x , y ) {A}_{j} ( x , y )} ;$$
wherein sfᵢ is the scaling factor for the one of the picker instances of the at least one pair of the picker instances, the truckload is the weight of the crop harvested from the field by the one of the picker instances of the at least one pair of the picker instances, nfᵢⱼ is the normalization factor for the at least one pair of the picker instances, Yⱼ(x,y) is a yield data point in mass of the crop yield per unit area collected by the other one of the picker instances of the at least one pair of the picker instances at the location (x,y), and Aⱼ(x,y) is an area associated with the yield data point Yⱼ(x,y).

5. The computer-implemented method of claim 1, wherein applying the scaling factor includes applying the scaling factor consistent with at least one of the following algorithms, thereby providing the normalized yield data:
norm_yldⱼ=(nfᵢⱼ×sfᵢ)Ŷⱼ(x, y); and
norm_yldᵢ=(sfᵢ)Ŷᵢ(x, y);
wherein norm_yldᵢ is the normalized yield data at location (x, y) for the picker instance i of the at least one pair of the picker instances, norm_yldⱼ is the normalized yield data at location (x,y) for the other one of the picker instances, j, of the at least one pair of the picker instances, nfᵢⱼ is the normalization factor for the at least one pair of the picker instances, sfᵢ is the scaling factor for the one of the picker instances of the at least one pair of the picker instances, Ŷⱼ(x,y) is the calculated yield for the other one of the picker instances of the at last one pair of picker instances at the location (x,y), and Ŷᵢ(x,y) is the calculated yield for the one of the picker instances of the at last one pair of the picker instances at the location (x,y).

6. The computer-implemented method of claim 1, further comprising compiling, by the computing device, a yield map for the field, based on the normalized yield data; and
wherein the at least one picker includes at least one of a corn ear picker and a combine harvester.

7. The computer-implemented method of claim 1, further comprising receiving, by the computing device, from at least one of the picker instances, the data for the field, the data including at least one or more of an electrical signal indicative of an amount of the crop harvested by the at least one of the picker instances and/or a calculated yield for the at least one of the picker instances based on a conversion factor associated with said at least one of the picker instances.

8. The computer-implemented method of claim 1, wherein the at least one picker includes multiple pickers, and wherein each of the picker instances is associated with one of the multiple pickers; and
wherein the method further comprises compiling a matrix of multiple normalization factors for the multiple pickers.

9. The computer-implemented method of claim 8, further comprising calculating one of the multiple normalization factors for a pair of the multiple pickers through an intermediary picker from the multiple pickers, based on the following:
$$n {f}_{i j} = \frac{{K}_{i}}{{K}_{j}} = \frac{{K}_{i}}{{K}_{k}} \frac{{K}_{k}}{{K}_{j}} = n {f}_{i k} n {f}_{k j} .$$

10. The computer-implemented method of claim 1, wherein multiple ones of the picker instances are associated with a same one of the at least one picker; and/or
wherein the at least one picker includes a first picker and a second picker, and wherein multiple ones of the picker instances are associated with the first picker and the second picker.

11. The computer-implemented method of claim 1, wherein the accessed data includes yield data for only a portion of the field; and
wherein the method further comprises, prior to determining the mass differential for the crop, approximating yield data for the field based on a distribution of the yield data for the portion of the field.

12. A system for adjusting yield data collected by pickers to account for errors in calibration of the pickers, the system comprising:
a data structure including yield data for a field harvested by multiple pickers, the yield data including actual yield data determined based on a weight of a crop harvested by the pickers from the field and calculated yield data based on conversion factors associated with each of the pickers; and
a field engine computing device in communication with the data structure, the field engine computing device configured to:
calculate a mass differential for a crop harvested by the pickers from the field based on the actual yield data and the calculated yield data in the data structure;
determine that the mass differential exceeds a threshold; and
in response to the determination that the mass differential exceeds the threshold:
calculate a normalization factor for at least one pair of the pickers;
calculate a scaling factor associated with one of the pickers of the at least one pair of the pickers based on the normalization factor;
apply the scaling factor to the calculated yield data for each of the pickers of the at least one pair of the pickers, such that the calculated yield data is normalized; and
store the normalized yield data for each of the pickers of the at least one pair of the pickers in the data structure.

13. The system of claim 12, wherein the field engine computing device is configured, in connection with calculating the normalization factor, to calculate a normalization factor for each pair of the pickers having at least a threshold number of neighboring data points within the accessed data, and wherein the neighboring data points include data points for adjacent swaths in the field.

14. The system of claim 12, wherein the field engine computing device is further configured, in connection with calculating the scaling factor associated with one of the pickers of the at least one pair of the pickers, to calculate the scaling factor based on the following algorithm:
$$s {f}_{i} = \frac{truckload}{{\sum }_{j = 1}^{n} {\sum }_{x , y} n {f}_{ij} {Y}_{j} ( x , y ) {A}_{j} ( x , y )} ;$$
wherein sfᵢ is the scaling factor for the one of the pickers of the at least one pair of the pickers, the truckload is the weight of the crop harvested from the field by the one of the pickers of the at least one pair of the pickers, nfᵢⱼ is the normalization factor for the at least one pair of the pickers, Yⱼ(x,y) is a yield data point in mass of the crop yield per unit area collected by the other one of the pickers of the at least one pair of pickers at the location (x,y), and Aⱼ(x,y) is an area associated with the yield data point Yⱼ(x,y).

15. The system of claim 12, wherein the field engine computing device is further configured, in connection with applying the scaling factor, to apply the scaling factor consistent with at least one of the following algorithms, thereby providing the normalized yield data:
norm_yldⱼ=(nfᵢⱼ×sfᵢ)Ŷⱼ(x, y); and
norm_yldᵢ=(sfᵢ)Ŷᵢ(x, y);
wherein norm_yldᵢ is the normalized yield data at location (x, y) for the picker i of the at least one pair of the pickers, norm_yldⱼ is the normalized yield data at location (x, y) for the other one of the pickers, j, of the at least one pair of the pickers, nfᵢⱼ is the normalization factor for the at least one pair of the pickers, sfᵢ is the scaling factor for the one of the pickers of the at least one pair of the pickers, Ŷⱼ(x,y) is the calculated yield for the other one of the pickers of the at last one pair of pickers at the location (x,y), and Ŷᵢ(x,y) is the calculated yield for the one of the pickers of the at last one pair of pickers at the location (x,y).

16. The system of claim 12, further comprising the pickers;
wherein each of the pickers is configured to transmit data for the crop harvested from field to the field engine computing device;
wherein the data transmitted by each of the pickers to the field engine computing device includes at least one or more of an electrical signal indicative of an amount of the crop harvested by the picker and/or the calculated yield for the picker based on the conversion factor associated with said picker; and
wherein each of the pickers includes a corn ear picker or a combine harvester.

17. A non-transitory computer readable storage medium including executable instructions for adjusting yield data collected by harvesting machines to account for errors in calibration of the harvesting machines, which when executed by at least one processor, cause the at least one processor to:
access data for a field harvested by at least one harvesting machine, wherein the accessed data includes actual yield data for the at least one harvesting machine determined based on a weight of a crop harvested by the at least one harvesting machine from the field and calculated yield data based on a conversion factor associated with each instance associated with the at least one harvesting machine;
calculate a mass differential for a crop harvested by each instance associated with the at least one harvesting machine from the field based on the actual yield data and the calculated yield data;
determine whether the mass differential exceeds a threshold; and
in response to the mass differential exceeding the threshold:
calculate a normalization factor for at least one pair of instances associated with the at least one harvesting machine;
calculate a scaling factor associated with one of the instances of the at least one pair of the instances based on the normalization factor;
apply the scaling factor to the calculated yield data for each of the instances of the at least one pair of the instances, such that the calculated yield data is normalized; and
store the normalized yield data for each of the instances of the at least one pair of the instances in a data structure.

18. The non-transitory computer readable storage medium of claim 17, wherein the executable instructions, when executed by the at least one processor in connection with calculating the scaling factor associated with one of the instances of the at least one pair of the instances, cause the at least one processor to calculate the scaling factor based on the following algorithm:
$$s {f}_{i} = \frac{truckload}{{\sum }_{j = 1}^{n} {\sum }_{x , y} n {f}_{ij} {Y}_{j} ( x , y ) {A}_{j} ( x , y )} ;$$
wherein sfᵢ is the scaling factor for the one of the instances of the at least one pair of the instances, the truckload is the weight of the crop harvested from the field by the one of the instances of the at least one pair of the instances, nfᵢⱼ is the normalization factor for the at least one pair of the instances, Yⱼ(x,y) is a yield data point in mass of the crop yield per unit area collected by the other one of the instances of the at least one pair of instances at the location (x,y), and Aⱼ(x,y) is an area associated with the yield data point Yⱼ(x,y).

19. The non-transitory computer readable storage medium of claim 17, wherein the executable instructions, when executed by the at least one processor in connection with applying the scaling factor, further cause the at least one processor to apply the scaling factor consistent with at least one of the following algorithms, thereby providing the normalized yield data:
norm_yldⱼ=(nfᵢⱼ×sfᵢ)Ŷⱼ(x, y); and
norm_yldᵢ=(sfᵢ)Ŷᵢ(x, y);
wherein norm_yldᵢ is the normalized yield data at location (x, y) for the instance i of the at least one pair of the instances, norm_yldⱼ is the normalized yield data at location (x, y) for the other one of the instances, j, of the at least one pair of the instances, nfᵢⱼ is the normalization factor for the at least one pair of the instances, sfᵢ is the scaling factor for the one of the instances of the at least one pair of the instances, Ŷⱼ(x,y) is the calculated yield for the other one of the instances of the at last one pair of instances at the location (x,y), and Ŷᵢ(x,y) is the calculated yield for the one of the instances of the at last one pair of instances at the location (x,y).

20. The non-transitory computer readable storage medium of claim 17, wherein the at least one harvesting machine includes at least one of a corn ear picker and a combine harvester; and
wherein:
the at least one harvesting machine includes multiple harvesting machines, and each of the instances includes one of the multiple harvesting machines; and/or
multiple ones of the instances are associated with a same one of the at least one harvesting machine.
